(19) United States
(12) Patent Application Publication
(10) Pub. No.: US 2018/0053352 A1
(43) Pub. Date: Feb. 22, 2018

(54) OCCLUDING AUGMENTED REALITY CONTENT OR THERMAL IMAGERY FOR SIMULTANEOUS DISPLAY

(71) Applicant: DAQRI, LLC, Los Angeles, CA (US)

(72) Inventors: Samuel Finding, Los Angeles, CA (US); Lucas Kazansky, Los Angeles, CA (US); Naveen Anand Gunalan, Monterey Park, CA (US)

(21) Appl. No.: 15/243,715

(22) Filed: Aug. 22, 2016

(51) Int. Cl. G06T 19/00; H04N 5/33; G02B 27/01

(52) U.S. Cl. CPC G06T 19/006; H04N 5/33; G02B 2027/0141; G02B 2027/0138; G02B 2027/014; G02B 27/017

(57) ABSTRACT

A wearable computing device provides augmented reality images of an environment in which the wearable computing device is worn. The wearable computing device is configured to detect one or more objects in the environment and acquire, by one or more cameras of the wearable computing device, one or more thermal images of at least one object of the detected one or more objects. The wearable computing device also determines at least one depth parameter value for at least one thermal image of the one or more thermal images and obtains augmented reality content to be displayed with the at least one thermal image. The wearable computing device further obtains instructions of whether one or more portions of the augmented reality content are to be occluded, and uses the at least one thermal image as an occlusion mask to occlude the one or more portions of the augmented reality content.

### TECHNICAL FIELD

The subject matter disclosed herein generally relates to displaying augmented reality content using a wearable computing device and, in particular, to displaying the augmented reality content using occlusion culling relative to one or more thermal images to be displayed via the wearable computing device.

### BACKGROUND

Augmented reality (AR) is a live direct or indirect view of a physical, real-world environment whose elements are augmented (or supplemented) by computer-generated sensory input such as sound, video, graphics or Global Positioning System (GPS) data. With the help of advanced AR technology (e.g., adding computer vision and object recognition) the information about the surrounding real world of the user becomes interactive. Device-generated (e.g., artificial) information about the environment and its objects can be overlaid on the real world.

Typically, a user uses a computing device to view the augmented reality. Conventional computing devices often show a view of the user's environment as it appears to the user (e.g., within the light wavelengths perceivable by the human eye). Such conventional computing devices may include a camera or other device for the user to view the user's environment. Augmented reality modifies this view by integrating computer-generated images with the view of the environment. However, the computer-generated images may appear at the incorrect depth within the view of the environment. This can be problematic, such as where additional content is to be integrated in the view of the environment.

### BRIEF DESCRIPTION OF THE DRAWINGS

Some embodiments are illustrated by way of example and not limited to the figures of the accompanying drawings.

FIG. 1 is a block diagram illustrating an example of a network environment suitable for a wearable computing device, according to an example embodiment.

FIG. 2 is a block diagram of the wearable computing device of FIG. 1, according to an example embodiment.

FIG. 3 is a block diagram illustrating different types of sensors used by the wearable computing device of FIG. 1, according to an example embodiment.

FIGS. 4A-4B illustrate one example of occlusion culling of augmented reality content by the wearable computing device of FIG. 1, according to an example embodiment.

FIGS. 5A-5B illustrate another example of occlusion culling of augmented reality content by the wearable computing device 104 of FIG. 1, according to another example embodiment.

FIG. 6 illustrates a further example of occlusion culling of augmented reality content by the wearable computing device of FIG. 1, according to an example embodiment.

FIG. 7 illustrates a method, according to an example embodiment, implemented by the wearable computing device of FIG. 1 for displaying augmented reality content with thermal images with occlusion.

FIGS. 8A-8B illustrate another method, according to an example embodiment, implemented by the wearable computing device of FIG. 1 for displaying augmented reality content with thermal images with occlusion.

FIG. 9 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

This disclosure provides for a wearable computing device configured to display augmented reality content by using thermal data with one or more occlusion culling techniques. In this regard, the wearable computing device is configured to display augmented reality content based on thermal data. Thus, augmented reality content may appear in front or behind of a real object depending on the thermal data associated with the real object. This approach to displaying augmented reality is a technical improvement over traditional means of displaying augmented reality because it adds a further degree of realism than in other conventional devices.

Accordingly, in one embodiment, the disclosed wearable computing device includes a machine-readable memory storing computer-executable instructions and at least one hardware processor in communication with the machine-readable memory that, when the computer-executable instructions are executed, configures the wearable computing device to perform a plurality of operations. The plurality of operations includes acquiring, by one or more cameras of the wearable computing device, thermal data in an environment in which the wearable computing device is being worn, obtaining augmented reality content to be displayed within the wearable computing device, and occluding one or more portions of the augmented reality content based on the thermal data.

In another embodiment of the wearable computing device, the plurality of operations further comprises displaying a thermal image corresponding to the thermal data with the occluded one or more portions of the augmented reality content.

In a further embodiment of the wearable computing device, the plurality of operations further comprises identifying a first plurality of coordinates corresponding to the augmented reality content, identifying a second plurality of coordinates corresponding to the thermal image, identifying a third plurality of coordinates selected from the first plurality of coordinates and the second plurality of coordinates, the third plurality of coordinates corresponding to coordinates that the first plurality of coordinates and the second plurality of coordinates have in common, and the thermal image is displayed at the third plurality of coordinates instead of the augmented reality content.

In yet another embodiment of the wearable computing device, the plurality of operations further comprises obtaining instructions whether one or more portions of the thermal image are to be occluded based on a comparison of at least one depth parameter value of the augmented reality content with the at least one depth parameter value of the thermal image, and in response to the obtained instructions indicating that one or more portions of the thermal image are to be occluded, displaying the augmented reality content instead of the one or more portions of the thermal image.

In yet a further embodiment of the wearable computing device, the thermal image comprises a plurality of pixels and the plurality of operations further comprises determining at least one depth parameter value for each pixel of the plurality of pixels.

In another embodiment of the wearable computing device, occluding the one or more portions of the augmented reality content comprises communicating the thermal data to a computer-implemented server in communication with the wearable computing device, and receiving instructions indicating which of the one or more portions of the augmented reality content are to be occluded.

In a further embodiment of the wearable computing device, a depth parameter value of the thermal image indicates a distance of an object associated with the thermal image from the wearable computing device.

In yet another embodiment of the wearable computing device, displaying the thermal image instead of the augmented reality content includes displaying one or more portions of the augmented reality content that are not to be occluded.

This disclosure also provides for a computer-implemented method for providing augmented reality images of an environment in which the wearable computing device is worn, the computer-implemented method comprising acquiring, by one or more cameras of the wearable computing device, thermal data in an environment in which the wearable computing device is being worn, obtaining augmented reality content to be displayed within the wearable computing device, and occluding one or more portions of the augmented reality content based on the thermal data.

In another embodiment of the computer-implemented method, the method further includes displaying a thermal image corresponding to the thermal data with the occluded one or more portions of the augmented reality content.

In a further embodiment of the computer-implemented method, the method includes identifying a first plurality of coordinates corresponding to the augmented reality content, identifying a second plurality of coordinates corresponding to the thermal image, identifying a third plurality of coordinates selected from the first plurality of coordinates and the second plurality of coordinates, the third plurality of coordinates corresponding to coordinates that the first plurality of coordinates and the second plurality of coordinates have in common, and the thermal image is displayed at the third plurality of coordinates instead of the augmented reality content.

In yet another embodiment of the computer-implemented method, the method includes obtaining instructions whether one or more portions of the thermal image are to be occluded based on a comparison of at least one depth parameter value of the augmented reality content with the at least one depth parameter value of the thermal image, and in response to the obtained instructions indicating that one or more portions of the thermal image are to be occluded, displaying the augmented reality content instead of the one or more portions of the thermal image.

In yet a further embodiment of the computer-implemented method, the thermal image comprises a plurality of pixels, and the method further includes determining at least one depth parameter value for each pixel of the plurality of pixels.

In another embodiment of the computer-implemented method, occluding the one or more portions of the augmented reality content comprises communicating the thermal data to a computer-implemented server in communication with the wearable computing device, and receiving instructions indicating which of the one or more portions of the augmented reality content are to be occluded.

In a further embodiment of the computer-implemented method, the at least one depth parameter value of the thermal image indicates a distance of an object associated with the thermal image from the wearable computing device.

In yet another embodiment of the computer-implemented method, displaying the thermal image instead of the augmented reality content includes displaying one or more portions of the augmented reality content that are not to be occluded.

This disclosure also describes a machine-readable memory storing computer-executable instructions that, when executed by at least one hardware processor, configures a wearable computing device to perform a plurality of operations, the plurality of operations comprising acquiring, by one or more cameras of the wearable computing device, thermal data in an environment in which the wearable computing device is being worn, obtaining augmented reality content to be displayed within the wearable computing device, and occluding one or more portions of the augmented reality content based on the thermal data.

In another embodiment of the machine-readable memory, the plurality of operations further comprises identifying a first plurality of coordinates corresponding to the augmented reality content, identifying a second plurality of coordinates corresponding to the thermal image, identifying a third plurality of coordinates selected from the first plurality of coordinates and the second plurality of coordinates, the third plurality of coordinates corresponding to coordinates that the first plurality of coordinates and the second plurality of coordinates have in common, and the thermal image is displayed at the third plurality of coordinates instead of the augmented reality content.

In a further embodiment of the machine-readable memory, the plurality of operations further includes obtaining instructions whether one or more portions of the thermal image are to be occluded based on a comparison of at least one depth parameter value of the augmented reality content with at least one depth parameter value of the thermal image, and in response to the obtained instructions indicating that one or more portions of the thermal image are to be occluded, displaying the augmented reality content instead of the one or more portions of the thermal image.

In yet another embodiment of the machine-readable memory, the thermal image comprises a plurality of pixels, and the plurality of operations further comprises determining at least one depth parameter value for each pixel of the plurality of pixels.

Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

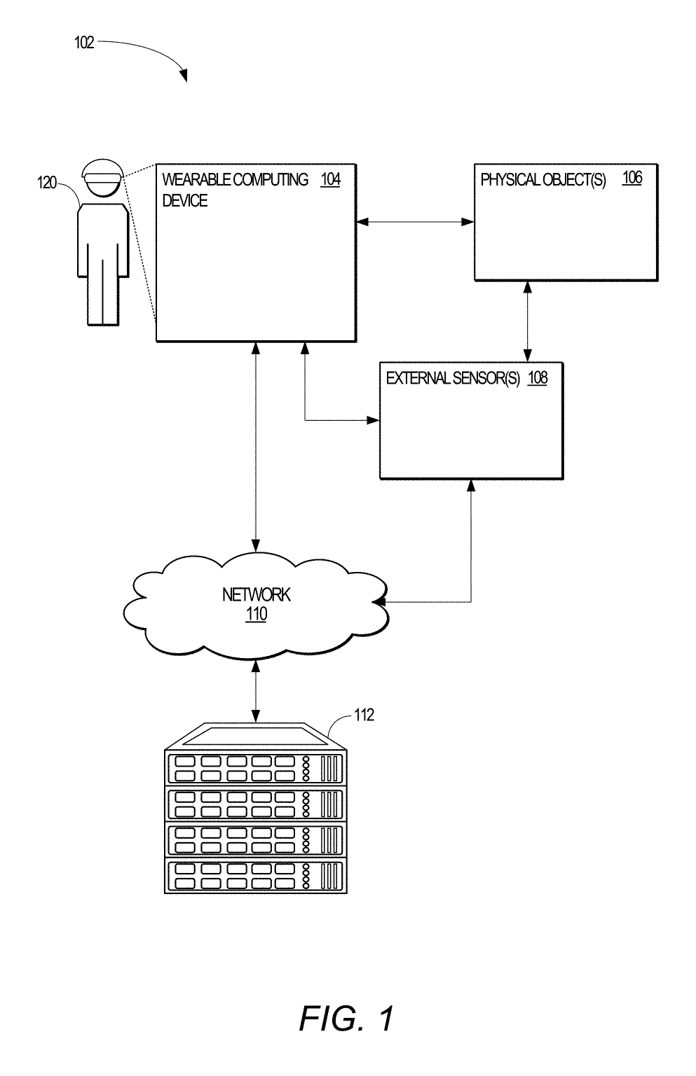

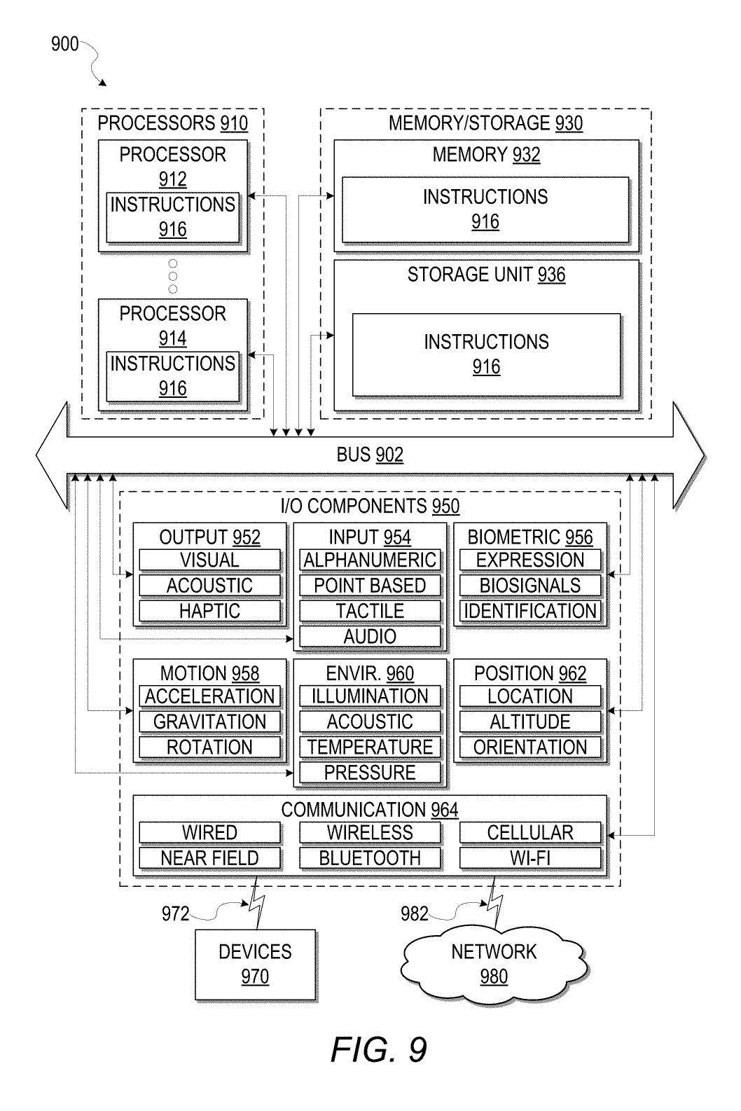

FIG. 1 is a block diagram illustrating an example of a network environment 102 suitable for a wearable computing device 104, according to an example embodiment. The network environment 102 includes the wearable computing device 104 and a server 112 communicatively coupled to each other via a network 110. The wearable computing device 104 and the server 112 may each be implemented in a computer system, in whole or in part, as described below with respect to FIG. 9.

The server 112 may be part of a network-based system. For example, the network-based system may be or include a cloud-based server system that provides additional information, such as three-dimensional (3D) models or other virtual objects, to the wearable computing device 104.

The wearable computing device 104 may be implemented in various form factors. In one embodiment, the wearable computing device 104 is implemented as a helmet, which the user 120 wears on his or her head, and views objects (e.g., physical object(s) 106) through a display device, such as one or more lenses, affixed to the wearable computing device 104. In another embodiment, the wearable computing device 104 is implemented as a lens frame, where the display device is implemented as one or more lenses affixed thereto. In yet another embodiment, the wearable computing device 104 is implemented as a watch (e.g., a housing mounted or affixed to a wrist band), and the display device is implemented as a display (e.g., liquid crystal display (LCD) or light emitting diode (LED) display) affixed to the wearable computing device 104.

A user 120 may wear the wearable computing device 104 and view one or more physical object(s) 106 in a real world physical environment. The user 120 may be a human user (e.g., a human being), a machine user (e.g., a computer configured by a software program to interact with the wearable computing device 104), or any suitable combination thereof (e.g., a human assisted by a machine or a machine supervised by a human). The user 120 is not part of the network environment 102, but is associated with the wearable computing device 104. For example, the wearable computing device 104 may be a computing device with a camera and a transparent display. In another example embodiment, the wearable computing device 104 may be hand-held or may be removably mounted to the head of the user 120. In one example, the display device may include a screen that displays what is captured with a camera of the wearable computing device 104. In another example, the display may be transparent or semi-transparent, such as lenses of wearable computing glasses or the visor or a face shield of a helmet.

The user 120 may be a user of an augmented reality (AR) application executable by the wearable computing device 104 and/or the server 112. The AR application may provide the user 120 with an AR experience triggered by one or more identified objects (e.g., physical object(s) 106) in the physical environment. For example, the physical object(s) 106 may include identifiable objects such as a two-dimensional (2D) physical object (e.g., a picture), a 3D physical object (e.g., a factory machine), a location (e.g., at the bottom floor of a factory), or any references (e.g., perceived corners of walls or furniture) in the real-world physical environment. The AR application may include computer vision recognition to determine various features within the physical environment such as corners, objects, lines, letters, and other such features or combination of features.

In one embodiment, the objects in an image captured by the wearable computing device 104 are tracked and locally recognized using a local context recognition dataset or any other previously stored dataset of the AR application. The local context recognition dataset may include a library of virtual objects associated with real-world physical objects or references. In one embodiment, the wearable computing device 104 identifies feature points in an image of the physical object 106. The wearable computing device 104 may also identify tracking data related to the physical object 106 (e.g., GPS location of the wearable computing device 104, orientation, or distance to the physical object(s) 106). If the captured image is not recognized locally by the wearable computing device 104, the wearable computing device 104 can download additional information (e.g., 3D model or other augmented data) corresponding to the captured image, from a database of the server 112 over the network 110.

In another example embodiment, the physical object(s) 106 in the image is tracked and recognized remotely by the server 112 using a remote context recognition dataset or any other previously stored dataset of an AR application in the server 112. The remote context recognition dataset may include a library of virtual objects or augmented information associated with real-world physical objects or references.

The network environment 102 also includes one or more external sensors 108 that interact with the wearable computing device 104 and/or the server 112. The external sensors 108 may be associated with, coupled to, or related to the physical object(s) 106 to measure a location, status, and characteristics of the physical object(s) 106. Examples of measured readings may include but are not limited to weight, pressure, temperature, velocity, direction, position, intrinsic and extrinsic properties, acceleration, and dimensions. For example, external sensors 108 may be disposed throughout a factory floor to measure movement, pressure, orientation, and temperature. The external sensor(s) 108 can also be used to measure a location, status, and characteristics of the wearable computing device 104 and the user 120. The server 112 can compute readings from data generated by the external sensor(s) 108. The server 112 can generate virtual indicators such as vectors or colors based on data from external sensor(s) 108. Virtual indicators are then overlaid on top of a live image or a view of the physical object(s) 106 (e.g., displayed on the display device 114) in a line of sight of the user 120 to show data related to the physical object(s) 106. For example, the virtual indicators may include arrows with shapes and colors that change based on real-time data. Additionally and/or alternatively, the virtual indicators are rendered at the server 112 and streamed to the wearable computing device 104.

The external sensor(s) 108 may include one or more sensors used to track various characteristics of the wearable computing device 104 including, but not limited to, the location, movement, and orientation of the wearable computing device 104 externally without having to rely on sensors internal to the wearable computing device 104. The external senor(s) 108 may include optical sensors (e.g., a depth-enabled 3D camera), wireless sensors (e.g., Bluetooth, Wi-Fi), Global Positioning System (GPS) sensors, and audio sensors to determine the location of the user 120 wearing the wearable computing device 104, distance of the user 120 to the external sensor(s) 108 (e.g., sensors placed in corners of a venue or a room), the orientation of the wearable computing device 104 to track what the user 120 is looking at (e.g., direction at which a designated portion of the wearable computing device 104 is pointed, e.g., the front portion of the wearable computing device 104 is pointed towards a player on a tennis court).

Furthermore, data from the external senor(s) 108 and internal sensors (not shown) in the wearable computing device 104 may be used for analytics data processing at the server 112 (or another server) for analysis on usage and how the user 120 is interacting with the physical object(s) 106 in the physical environment. Live data from other servers may also be used in the analytics data processing. For example, the analytics data may track at what locations (e.g., points or features) on the physical object(s) 106 or virtual object(s) (not shown) the user 120 has looked, how long the user 120 has looked at each location on the physical object(s) 106 or virtual object(s), how the user 120 wore the wearable computing device 104 when looking at the physical object(s) 106 or virtual object(s), which features of the virtual object(s) the user 120 interacted with (e.g., such as whether the user 120 engaged with the virtual object), and any suitable combination thereof. To enhance the interactivity with the physical object(s) 106 and/or virtual objects, the wearable computing device 104 receives a visualization content dataset related to the analytics data. The wearable computing device 104, via the display device 114, then generates a virtual object with additional or visualization features, or a new experience, based on the visualization content dataset.

Any of the machines, databases, or devices shown in FIG. 1 may be implemented in a general-purpose computer modified (e.g., configured or programmed) by software to be a special-purpose computer to perform one or more of the functions described herein for that machine, database, or device. For example, a computer system able to implement any one or more of the methodologies described herein is discussed below with respect to FIG. 9. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 110 may be any network that facilitates communication between or among machines (e.g., server 112), databases, and devices (e.g., the wearable computing device 104 and the external sensor(s) 108). Accordingly, the network 110 may be a wired network, a wireless network (e.g., a mobile or cellular network), or any suitable combination thereof. The network 110 may include one or more portions that constitute a private network, a public network (e.g., the Internet), or any suitable combination thereof.

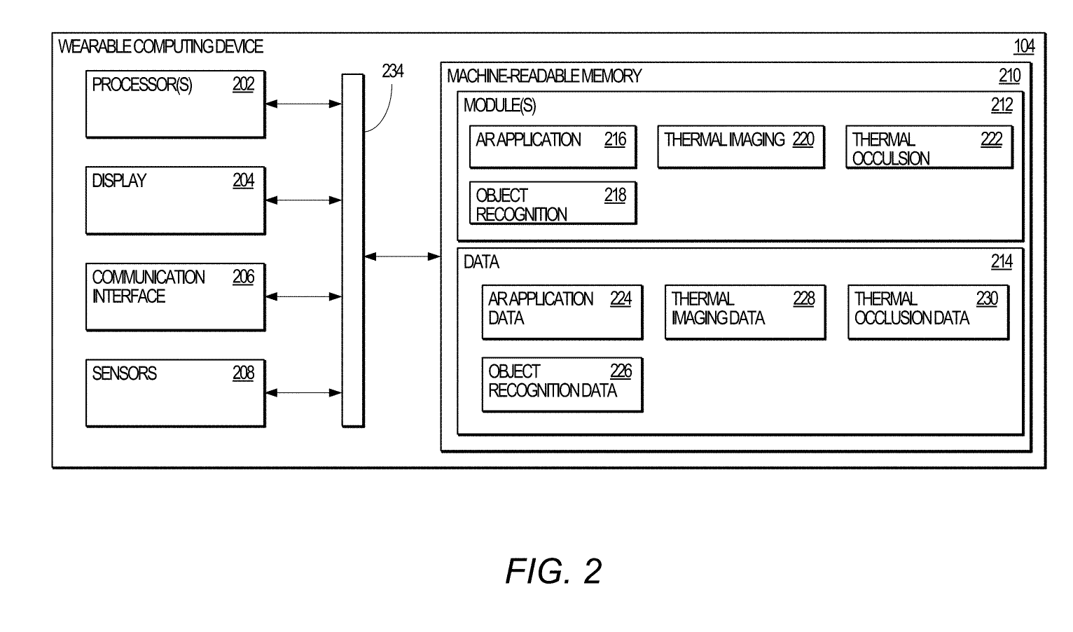

FIG. 2 is a block diagram of the wearable computing device 104 of FIG. 1, according to an example embodiment. The wearable computing device 104 includes various different types of hardware components. In one embodiment, the wearable computing device includes one or more processor(s) 202, a display 204, a communication interface 206, and one or more sensors 208. The wearable computing device 104 also includes a machine-readable memory 210. The various components 202-210 communicate via a communication bus 234.

The one or more processors 202 may be any type of commercially available processor, such as processors available from the Intel Corporation, Advanced Micro Devices, Qualcomm, Texas Instruments, or other such processors. Further still, the one or more processors 202 may include one or more special-purpose processors, such as a Field-Programmable Gate Array (FPGA) or an Application Specific Integrated Circuit (ASIC). The one or more processors 202 may also include programmable logic or circuitry that is temporarily configured by software to perform certain operations. Thus, once configured by such software, the one or more processors 202 become specific machines (or specific components of a machine) uniquely tailored to perform the configured functions and are no longer general-purpose processors.

The display 204 may include a display surface or lens configured to display AR content (e.g., images, video) generated by the one or more processor(s) 202. In one embodiment, the display 204 is made of a transparent material (e.g., glass, plastic, acrylic, etc.) so that the user 120 can see through the display 204. In another embodiment, the display 204 is made of several layers of a transparent material, which creates a diffraction grating within the display 204 such that images displayed on the display 204 appear holographic. The processor(s) 202 are configured to display a user interface on the display 204 so that the user 120 can interact with the wearable computing device 104.

The communication interface 206 is configured to facilitate communications between the wearable computing device 104, the user 120, the external sensor(s) 108, and the server 112. The communication interface 206 may include one or more wired communication interfaces (e.g., Universal Serial Bus (USB), an I²C bus, an RS-232 interface, an RS-485 interface, etc.), one or more wireless transceivers, such as a Bluetooth® transceiver, a Near Field Communication (NFC) transceiver, an 802.11x transceiver, a 3G (e.g., a GSM and/or CDMA) transceiver, a 4G (e.g., LTE and/or Mobile WiMAX) transceiver, or combinations of wired and wireless interfaces and transceivers. In one embodiment, the communication interface 206 interacts with the sensors 208 to provide input to the wearable computing device 104. In this embodiment, the user 120 may engage in gestures, eye movements, speech, or other physical activities that the wearable computing device 104 interprets as input (e.g., via the AR application 214 and/or input detection module 218).

To detect the movements of the user 120, the wearable computing device 104, and/or other objects in the environment, the wearable computing device 104 includes one or more sensors 208. The sensors 208 may generate internal tracking data of the wearable computing device 104 to determine a position and/or an orientation of the wearable computing device 104. In addition, the sensors 208 cooperatively operate so as to assist the wearable computing device 104 in identifying objects and obtaining thermal imagery for objects within the environment where the wearable computing device 104 is located.

The position and the orientation of the wearable computing device 104 may be used to identify real-world objects in a field of view of the wearable computing device 104. For example, a virtual object may be rendered and displayed in the display 204 when the sensors 208 indicate that the wearable computing device 104 is oriented towards a real-world object (e.g., when the user 120 looks at one or more physical object(s) 106) or in a particular direction (e.g., when the user 120 tilts his head to watch his wrist).

The wearable computing device 104 may display a virtual object in response to a determined geographic location of the wearable computing device 104. For example, a set of virtual objects may be accessible when the user 120 of the wearable computing device 104 is located in a particular building. In another example, virtual objects, including sensitive material, may be accessible when the user 120 of the wearable computing device 104 is located within a predefined area associated with the sensitive material and the user 120 is authenticated. Different levels of content of the virtual objects may be accessible based on a credential level of the user 120. For example, a user who is an executive of a company may have access to more information or content in the virtual objects than a manager at the same company. The sensors 208 may be used to authenticate the user 120 prior to providing the user 120 with access to the sensitive material (e.g., information displayed in as a virtual object such as a virtual dialog box in a transparent display). Authentication may be achieved via a variety of methods such as providing a password or an authentication token, or using sensors 208 to determine biometric data unique to the user 120.

The wearable computing device 104 is further configured to display thermal imagery corresponding to objects detected by the wearable computing device 104. In one embodiment, the wearable computing device 104 detects objects within its environment and obtains thermal imagery corresponding to the detected object. The wearable computing device 104 may display the thermal imagery as augmented reality content, or may display the thermal imagery while the wearable computing device 104 is operating in an infrared imaging mode.

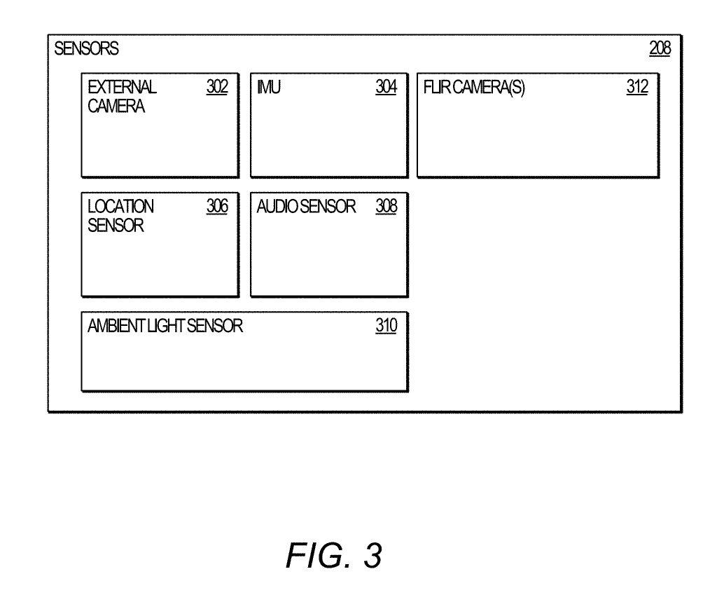

FIG. 3 is a block diagram illustrating different types of sensors 208 used by the wearable computing device 104 of FIG. 1, according to an example embodiment. For example, the sensors 208 may include an external camera 302, an inertial measurement unit (IMU) 304, a location sensor 306, an audio sensor 308, an ambient light sensor 310, and one or more forward looking infrared (FLIR) camera(s) 312. One of ordinary skill in the art will appreciate that the sensors illustrated in FIG. 3 are examples, and that different types and/or combinations of sensors may be employed in the wearable computing device 104.

The external camera 302 includes an optical sensor(s) (e.g., camera) configured to capture images across various spectrums. For example, the external camera 302 may include an infrared camera or a full-spectrum camera. The external camera 302 may include a rear-facing camera(s) and a front-facing camera(s) disposed in the wearable computing device 104. The front-facing camera(s) may be used to capture a front field of view of the wearable computing device 104 while the rear-facing camera(s) may be used to capture a rear field of view of the wearable computing device 104. The pictures captured with the front- and rear-facing cameras may be combined to recreate a 360-degree view of the physical environment around the wearable computing device 104.

The IMU 304 may include a gyroscope and an inertial motion sensor to determine an orientation and/or movement of the wearable computing device 104. For example, the IMU 304 may measure the velocity, orientation, and gravitational forces on the wearable computing device 104. The IMU 304 may also measure acceleration using an accelerometer and changes in angular rotation using a gyroscope.

The location sensor 306 may determine a geolocation of the wearable computing device 104 using a variety of techniques such as near field communication (NFC), the Global Positioning System (GPS), Bluetooth®, Wi-Fi®, and other such wireless technologies or combination of wireless technologies. For example, the location sensor 306 may generate geographic coordinates and/or an elevation of the wearable computing device 104.

The audio sensor 308 may include one or more sensors configured to detect sound, such as a dynamic microphone, condenser microphone, ribbon microphone, carbon microphone, and other such sound sensors or combinations thereof. For example, the microphone may be used to record a voice command from the user (e.g., user 120) of the wearable computing device 104. In other examples, the microphone may be used to measure an ambient noise (e.g., measure intensity of the background noise, identify specific type of noises such as explosions or gunshot noises).

The ambient light sensor 310 is configured to determine an ambient light intensity around the wearable computing device 104. For example, the ambient light sensor 314 measures the ambient light in a room in which the wearable computing device 104 is located. Examples of the ambient light sensor 310 include, but are not limited to, the ambient light sensors available from ams AG, located in Oberpremstätten, Austria.

The one or more FLIR camera(s) 312 are configured to capture and/or obtain thermal imagery of objects being viewed by the wearable computing device 104 (e.g., by the external camera 302). One of ordinary skill in the art will appreciate that the FLIR camera(s) 312 illustrated in FIG. 3 and described below are examples, and that different types and/or combinations of infrared imaging devices may be employed in the wearable computing device 104.

The FLIR camera(s) 312 may be affixed to different parts and/or surfaces of the wearable computing device 104 depending upon its implementation. For example, where the wearable computing device 104 is implemented as a head-mounted device, one or more of the FLIR camera(s) 312 may be affixed or mounted in a forward-looking or rearward-looking position on an exterior or interior surface of the wearable computing device 104. As another example, where the wearable computing device 104 is implemented as a wrist-mounted device (e.g., a watch), one or more of the FLIR camera(s) 312 may be affixed or disposed on a surface perpendicular to a surface having the display 204. In either examples, the one or more FLIR camera(s) 312 are arranged or disposed within the wearable computing device 104 such that the FLIR camera(s) 312 obtain thermal imagery within the environment of the wearable computing device 104.

In one embodiment, the FLIR camera(s) 312 are configured to capture thermal imagery of objects detected by the wearable computing device 104 and/or designated by the user 120. In this embodiment, the FLIR camera(s) 312 may operate so as to capture the thermal energy being emitted by the designated object(s). In another embodiment, the FLIR camera(s) 312 are configured to capture thermal imagery without the explicit designation of object(s) by the user, in which case, the wearable computing device 104 and/or the server 112 then selectably associates the captured thermal imagery to correspond to object(s) detected by the wearable computing device 104 and/or the server 112. Further still, the wearable computing device 104 and/or the server 112 may leverage the obtained thermal imagery to detect and/or identify object(s). As discussed below with reference to FIG. 2, the obtained thermal imagery may then be projected on the display 204 to be viewed by the user 120.

Referring back to FIG. 2, the machine-readable memory 210 includes various modules 212 and data 214 for implementing the features of the wearable computing device 104. The machine-readable memory 210 includes one or more devices configured to store instructions and data temporarily or permanently and may include, but not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable memory” should be taken to include a single medium or multiple media (e.g., a centralized or distributed database, or associated caches and servers) able to store the modules 212 and the data 214. Accordingly, the machine-readable memory 210 may be implemented as a single storage apparatus or device, or, alternatively and/or additionally, as “cloud-based” storage systems or storage networks that include multiple storage apparatus or devices. As shown in FIG. 2, the machine-readable memory 210 excludes signals per se.

In one embodiment, the modules 212 are written in a computer-programming and/or scripting language. Examples of such languages include, but are not limited to, C, C++, C#, Java, JavaScript, Perl, Python, Ruby, or any other computer programming and/or scripting language now known or later developed.

The modules 212 include one or more modules 216-224 that implement the features of the wearable computing device 104. In one embodiment, the modules 212 include an AR application 216, an object recognition module 218, a thermal imaging module 220, and a thermal occlusion module 222. The data 214 includes one or more different sets of data 224-230 used by, or in support of, the modules 212. In one embodiment, the data 214 includes AR application data 224, object recognition data 226, thermal imaging data 228, and thermal occlusion data 230.

The AR application 216 is configured to provide the user 120 with an AR experience triggered by one or more of the physical object(s) 106 in the user's 120 environment. Accordingly, the machine-readable memory 210 also stores AR application data 224 which provides the resources (e.g., sounds, images, text, and other such audiovisual content) used by the AR application 216. In response to detecting and/or identifying physical object(s) 106 in the user's 120 environment, the AR application 216 generates audiovisual content (e.g., represented by the AR application data 224) that is displayed on the display 204. To detect and/or identify the physical object(s) 106, the AR application 216 may employ various object recognition algorithms and/or image recognition algorithms.

The AR application 216 may further generate and/or display interactive audiovisual content on the display 204. In one embodiment, the AR application 214 generates an interactive graphical user interface that the user 120 may use to interact with the AR application 216 and/or control various functions of the wearable computing device 104. In addition, the wearable computing device 104 may translate physical movements and/or gestures, performed by the user 120, as input for the graphical user interface.

The object recognition module 218 is configured to identify and/or detect objects within the environment of the wearable computing device 104. In one embodiment, the object recognition module 218 communicates with one or more of the sensors 208 to identify the objects within the environment. For example, and with reference to FIG. 3, the external camera 302 may communicate one or more images to the object recognition module 218, which then performs one or more object recognition algorithms on the received images. The objects identified and/or detected by the object recognition module 218 are then stored as the object recognition data 226. The object recognition module 218 may perform object recognition on the images for previously unidentified objects and may also perform the object recognition on the images according to predefined fiducial markers. With previously unidentified objects, the object recognition module 218 may reference a database of objects and/or a classifier (e.g., via the server 112) to classify the unidentified objects and, with fiducial markers, may reference a database of fiducial markers to identify the object to which the fiducial marker is affixed.

In an alternative embodiment, the object recognition module 218 communicates the images obtained by the sensors 208 to the server 112, which performs the object recognition and/or detection algorithms on the received images. The server 112 communicates the detected objects to the object recognition module 218 via the communication interface 206, which then stores the detected objects as the object recognition data 226.

The object recognition data 226 may store a variety of information about a given object. In one embodiment, such information may include the type of object, whether the object is assigned a formal or informal name, the location of the object relative to the Earth (e.g., via latitude, longitude, and elevation coordinates), and the location of the object relative to the wearable computing device 104 (e.g., distance, elevation, etc.)

The thermal imaging module 220 is configured to acquire one or more thermal images of the environment and/or selected objects being viewed by the wearable computing device 104. In one embodiment, the thermal imaging module 220 communicates with one or more sensors 208 (e.g., the FLIR camera(s) 312) to acquire the one or more thermal images. The thermal images acquired by the thermal imaging module 220 are then stored as the thermal imaging data 228. In one embodiment, the thermal imaging module 220 acquires the thermal imaging data 228 at a framerate equal to, or higher than, the framerate perceivable by the human eye (e.g., 30 frames per second, 23.97 frames per second, 29.97 frames per second, etc.). In this embodiment, the thermal imaging data 228 may be displayed by the AR application 216, which appears as a video of thermal imagery to the user 120.

In one embodiment, the wearable computing device 104 is configured to display the thermal imaging data 228 in one or more modes. In one mode (e.g., a full spectrum mode) the thermal imaging data 228 is displayed as augmented reality content via the AR application 216. In this first mode, the thermal imaging data 228 may be integrated with other augmented reality content (e.g., via the AR application data 224). In another mode (e.g., an infrared imaging mode), the AR application 216 displays the environment according to the infrared spectrum, where objects appearing in the environment are colorized to indicate the amount of thermal energy being emitted by corresponding objects. In this second mode, the thermal imaging data 228 is displayed instead of the environment as it appears within the visible light spectrum. In one embodiment, the thermal imaging module 220 correlates colors to one or more temperatures such that the thermal imaging data 228 is displayed as colorized information. For example, objects emitting less heat (e.g., are colder) may be colorized with such colors as blue and purple, whereas objects emitting more heat (e.g., are warmer), may be colorized with yellow, orange, and/or red. Additionally and/or alternatively, the colors corresponding to the thermal imaging data 228 may be selected from a greyscale, where cooler temperatures are associated with darker colors of the greyscale, and warmer temperatures are associated with light colors of the greyscale.

In displaying augmented reality content, whether the augmented reality content includes thermal imaging data 228 or other audio and/or visual data (e.g., graphical overlays, interactive buttons, dialog prompts, etc.), there may be times when the augmented reality content is to be displayed as though it appears behind physical objects within the environment of the wearable computing device 104. Accordingly, in one embodiment, the wearable computing device 104 includes or instantiates a thermal occlusion module 222 that facilitates the occlusion culling of augmented reality content when it is displayed along with thermal imaging data 228. The thermal occlusion module 222 may be incorporated into the AR application 216 or may be instantiated as a separate plugin or circuit that operates cooperatively with the AR application 216.

In one embodiment, the thermal occlusion module 222 performs thermal occlusion of augmented reality content according to whether one or more thermal images (e.g., via the thermal imaging data 228) are also to be displayed. In this embodiment, the thermal occlusion module 222 performs masking via the thermal image such that the augmented reality content is not rendered over the thermal image or a portion thereof.

For example, one or more portions of a thermal image may be designated for display at a first set of coordinates (e.g., two-dimensional coordinates) of the display 204, and the augmented reality content may be designated for display at a second set of coordinates (e.g., two-dimensional coordinates) of the display 204. However, one or more of the coordinates of the first set of coordinates and the second set of coordinates may be the same set of coordinates (e.g., the coordinates overlap). As it is possible that the AR application 216 may render the augmented reality content first rather than the thermal image, the thermal occlusion module 222 provides instructions to the AR application 216 as to which image should be rendered (e.g., the thermal image or the augmented reality content). In one embodiment, the thermal occlusion module 222 initially determines which coordinates from the two set of coordinates overlap. The thermal occlusion module 222 may perform this determination by identifying matching coordinates associated with the thermal image and with the augmented reality content. For these overlapping coordinates, the thermal occlusion module 222 identifies those coordinates that are associated with the thermal image (e.g., as a third set of coordinates). These identified coordinates may be stored as the thermal occlusion data 230.

The thermal occlusion module 222 then instructs the AR application 216 to render the thermal image associated with the third set of coordinates. In effect, the AR application 216 displays the thermal image as a mask such that the augmented reality content is not rendered over it. Accordingly, the thermal image appears overlaid the augmented reality content instead of the augmented reality content being overlaid (or replacing) the thermal image.

The foregoing example of thermal occlusion of augmented reality content is one example of how the thermal occlusion module 222 may interact with augmented reality content and thermal imaging data 228. In another embodiment, the thermal occlusion module 222 leverages a depth parameter to determine which content should appear closer to the user 120. As mentioned previously, objects detected by the object recognition module 218 may be associated with a set of coordinates (e.g., three-dimensional coordinates) relative to the wearable computing device. Similarly, augmented reality content to be displayed by the AR application 216 may associated with a depth parameter, e.g., a value that indicates whether the augmented reality content is to appear in front of, or behind, other objects within the environment of the wearable computing device 104. The depth parameter may be assigned a range of values from zero to one, inclusive, where zero indicates that the augmented reality content is to be the foremost object and a one indicates that the augmented reality content is to be the most background object. The depth parameter may also correspond to the depth of an object having been detected by the object recognition module 218. In one example, the depth parameter for each of the pixels of augmented reality content to be displayed is based on, or corresponds to, the depth parameter for each pixel of an image of an object having been recognized by the object recognition module 218 (e.g., as part of the object recognition data 226).

In this alternative embodiment, the depth parameters for pixels of thermal imaging data 228 may be stored as the thermal occlusion data 230. Although the depth parameters for the thermal imaging data 228 may be determined or obtained from the object recognition data 226, the depth parameters may also be obtained from one or more of the sensors 208 as the thermal imaging data 228 is being acquired. Using the various depth parameters, the thermal occlusion module 222 then performs occlusion culling using one or more occlusion culling techniques, such as potentially visible set rendering, portal rending, hierarchical occlusion maps, and other such occlusion culling techniques. While assigning depth parameter values to individual pixels is one manner in which the thermal occlusion module 222 may operate, other types of occlusion culling may be performed, such as by assigning one or more bounding boxes to objects and determining the ordering in which the bounding boxes are to be displayed. Thus, while depth parameter values at the pixel level is one manner in which occlusion culling may be performed, other techniques, and their equivalents, are also contemplated as falling within the scope of this disclosure.

Having performed the occlusion culling of the augmented reality content to be displayed, the thermal occlusion module 222 cooperates with the AR application 216 to complete the rendering of the augmented reality content on the display 204. While the thermal occlusion culling performed by the thermal occlusion module 222 increases the immersive experience of the user 120, it also increases the performance of the wearable computing device 104 because the AR application 216 draws only those pixels that have the lowest depth parameter value.

While the foregoing embodiments are discussed as alternatives, one of ordinary skill in the art will appreciate that such embodiments may be combined or varied without departing from the scope of this disclosure. For example, the thermal occlusion module 222 may employ a combination of the two embodiments discussed above. In this example, the thermal occlusion module 222 may engage in a first determination of which coordinates of thermal images are to be rendered instead of the coordinates associated with augmented reality content, and then a second determination of which thermal images are to overlap other thermal images (e.g., by referencing one or more depth parameters associated with their respective thermal images). Thus, the foregoing embodiments are not mutually exclusive and may be implemented to operate consecutively and/or cooperatively within the wearable computing device 104.

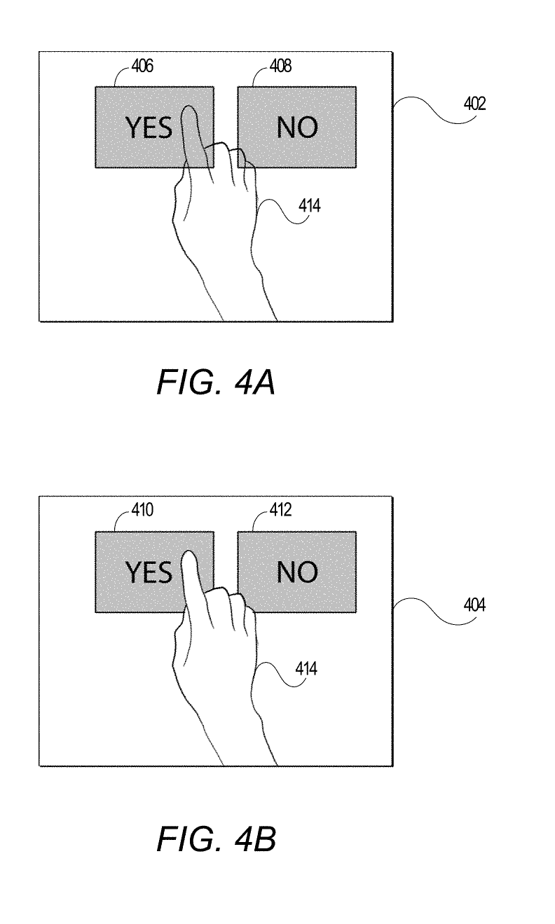

FIGS. 4A-4B illustrate one example of occlusion culling of augmented reality content by the wearable computing device 104 of FIG. 1, according to an example embodiment. In FIG. 4A, the user 120 views a scene 402 via the display 204 that includes a thermal image 414 and augmented reality content 406-408. In the example illustrated in FIG. 4A, the thermal image 414 includes the user's hand and the augmented reality content 406-408 includes graphical buttons 406-408 displayed via the display 204. The graphical buttons 406-408 may be part of a graphical user interface that the user 120 uses to interact with the wearable computing device 104. The thermal image 414 may be stored as the thermal imaging data 228, and the graphical buttons 406-408 may be stored as augmented reality content displayable by the AR application 216. However, in the example shown in FIG. 4A, the thermal occlusion module 222 has not been invoked on the graphical buttons 406-408. Thus, the thermal occlusion module 222 has not determined that the coordinates associated with the thermal image 414 are to be rendered instead of the coordinates associated with the graphical buttons 406-408.

In contrast, FIG. 4B illustrates a scene 404 where the thermal occlusion module 222 has been invoked for the thermal image 414 and augmented reality content 410-412 (e.g., a first graphical button 410 and a second graphical button 412).

As shown in FIG. 4B, a thermal image 414 appears in front of the graphical button 410 and the graphical button 412. In one embodiment, the thermal occlusion module 222 determines which coordinates of the display 204 are associated with the thermal image 414 and which coordinates of the display 204 are associated with the graphical buttons 410-412. In this embodiment, the thermal occlusion module 222 determines that the overlapping coordinates (e.g., the coordinates that correspond to both the thermal image 414 and the graphical buttons 410-412) are to display the thermal image 414 instead of the graphical buttons 410-412. In this manner, the thermal occlusion module 22 designates the thermal image 414 as a mask such that the graphical buttons 410-412 are not rendered over it.

In an alternative embodiment, the thermal occlusion module 222 determines which content to render based on a depth parameter assigned to the thermal image 414 and the graphical buttons 410-412. In this embodiment, the pixels of the graphical button 410 and the pixels of the graphical button 412 have each been assigned a depth parameter value higher than the depth parameter values assigned to the pixels of the thermal image 414. Thus, the AR application 216 displays those pixels of the thermal image 414 rather than the pixels of the graphical button 410 or the graphical button 412, depending on where the pixel of the thermal image 414 is to be displayed. Accordingly, the thermal image 414 appears in front of the augmented reality content 410-412. In this manner, the thermal occlusion module 222 increases the immersive experience of the user 120 while also accelerating the manner in which augmented reality content is displayed.

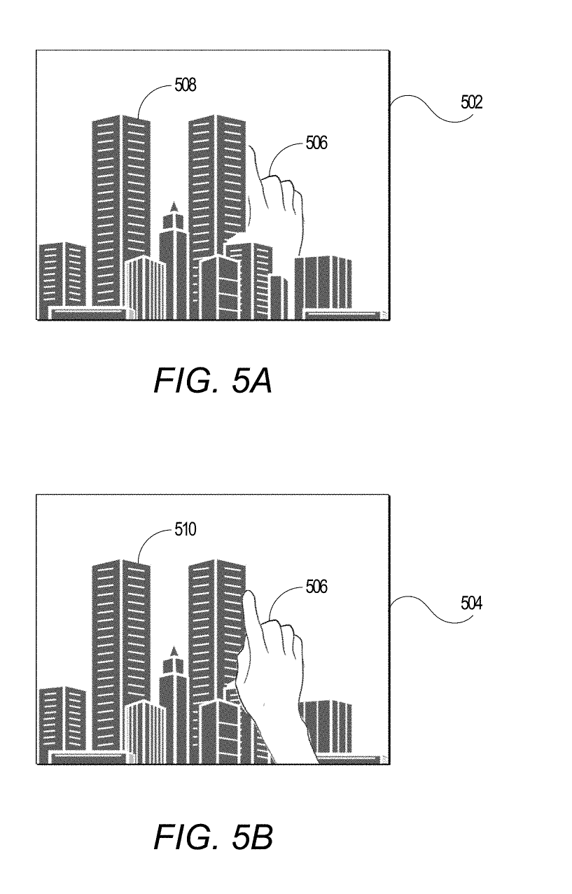

FIGS. 5A-5B illustrate another example of occlusion culling of augmented reality content by the wearable computing device 104 of FIG. 1, according to another example embodiment. In FIG. 5A, the user 120 views a scene 502 via the display 204 that includes a thermal image 506 and augmented reality content 508. In the example illustrated in FIG. 5A, the thermal image 506 includes the user's hand and the augmented reality content 508 includes a graphical image of a city skyline 508 displayed via the display 204. The thermal image 506 may be stored as the thermal imaging data 228, and the graphical image 508 may be stored as augmented reality content displayable by the AR application 216. However, in the example shown in FIG. 5A, the thermal occlusion module 222 has not been invoked on the images displayed in the view 502, namely, the thermal image 506 of the user's hand and the augmented reality content 508 of the city skyline. As the thermal occlusion module 222 has not performed occlusion culling on either the augmented reality content 508 or the thermal image 506, both images 506-508 appear within the same geometric plane. Thus, when the user 120 views the scene 502, the user 120 cannot readily discern which objects are closer and which objects are further away.

In contrast, FIG. 5B illustrates a scene 504 where the thermal occlusion module 222 has performed occlusion culling on the thermal image 506 and the augmented reality content 510 (e.g., the graphical image of the city skyline). As shown in FIG. 5B, the thermal image 506 appears in front of the augmented reality content 510. In this regard, thermal occlusion module 222 has determined that the pixels (e.g., the coordinates) associated with the thermal image 506 are to be displayed instead of the pixels associated with the augmented reality content 510. In effect, the thermal image 506 is designated as a mask, which indicates that the augmented reality content 510 should not be rendered over it. In this embodiment, the AR application 216 receives an instruction that the thermal image 506 is to appear in the pixels that are shared by the thermal image 506 and the augmented reality content 510.

Alternatively, and/or additionally, the thermal occlusion module 222 may determine that the augmented reality content 510 has a greater depth parameter value (e.g., that the augmented reality content 510 is closer to the background) than the thermal image 506. Thus, the AR application 216 displays those portions of the thermal image 506 having the lesser depth parameter value (e.g., closer to zero) instead of the portions of the augmented reality content 510. Accordingly, the thermal image 506 appears in front of the augmented reality content 510. In this manner, the thermal occlusion module 222 increases the immersive experience of the user 120 while also accelerating the manner in which augmented reality content is displayed.

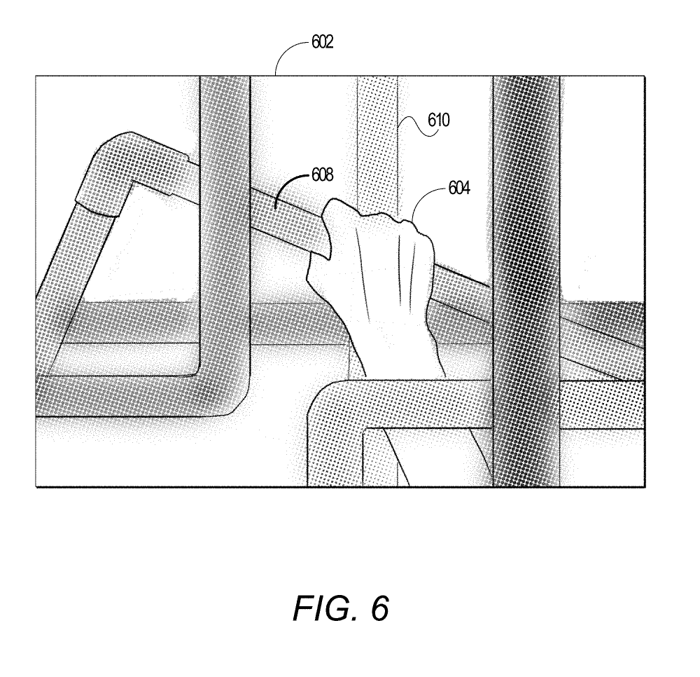

FIG. 6 illustrates a further example of occlusion culling of augmented reality content by the wearable computing device of FIG. 1, according to an example embodiment. In FIG. 6, the user 120 views a scene 602 via the display 204 that includes a first set of thermal imagery 608, a thermal image 604, and one or more objects 610 having been detected by the object recognition module 218. In particular, the one or more objects 610 include various pipes (e.g., water pipes, steam pipes, etc.), where the object recognition module 218 has identified the various individual pipes.

The thermal imagery 608 includes one or more images representing the thermal energy being emitted by one or more of the objects 610. As explained previously, the thermal imaging module 220 is configured to obtain the thermal imagery 608 via the one or more FLIR camera(s) 312. As with the object recognition data 226, the thermal imagery 608 may also be associated with a corresponding location relative to the wearable computing device 104, which is stored as the thermal imaging data 228. Using one or more graphical transformation techniques (e.g., translation, rotation, scaling, skewing, etc.), the AR application 216 aligns the obtained thermal imagery 608 with the detected objects 610 according to the object recognition data 226 and the thermal imaging data 228. In one embodiment, the operations include aligning a coordinate system used to obtain the thermal imagery 608 with a coordinate system used in detecting the one or more objects 610. Thus, when the AR application 216 displays the thermal imagery 608, the thermal imagery 608 appears overlaid on its corresponding object 610. In this manner, the thermal imagery 608 can be visualized in real-time, or approximate real-time, as the one or more objects 610 are being viewed by the user 120.

The scene 602 also illustrated in FIG. 6 includes a thermal image 604 of the user's hand. As explained above, the thermal imaging module 220 acquires the thermal image 604 from one or more of the sensors 208 (e.g., the one or more FLIR camera(s) 312). As with the thermal imagery 608, the thermal image 604 is also associated with a location relative to the wearable computing device 104 (e.g., a two-dimensional coordinate and a depth parameter). Notably, the thermal imagery 608 may be displayed concurrently with the thermal image 604. As discussed above, the thermal occlusion module 222 is configured to determine which image (or portions thereof) is to be rendered and which image (or portions thereof) may not be rendered determines which of the pixels of the thermal image 604 and which of the pixels of the thermal imagery 608 are to be displayed. This determination may be stored as the thermal occlusion data 230. Accordingly, when the AR application 216 renders the thermal imagery 608 and the thermal image 604, the AR application 216 references the thermal occlusion data 230 to determine which sets of pixels are to be displayed on the display 204. Thus, the thermal image 604 appears to be in front of the thermal imagery 608 when viewed via the display 204.

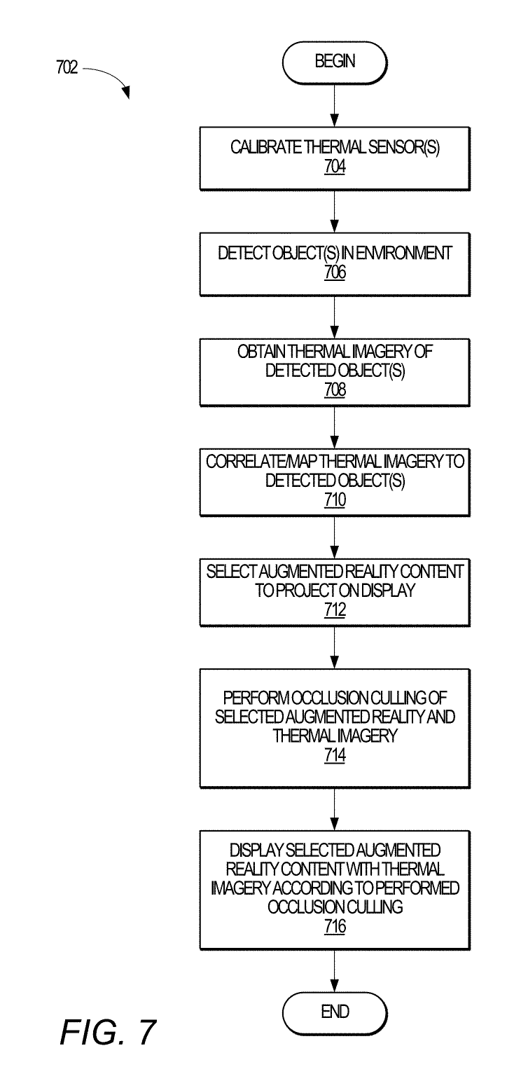

FIG. 7 illustrates a method 702, according to an example embodiment, implemented by the wearable computing device 104 of FIG. 1 for displaying augmented reality content with thermal images with occlusion. The method 702 may be implemented by one or more components of the wearable computing device 104 and is discussed by way of reference thereto.

Initially, the wearable computing device 104 may be thermally calibrated (Operation 704). Thermally calibrating the wearable computing device 104 may include exposing the one or more FLIR camera(s) 312 to ambient environment temperatures such that the FLIR camera(s) 312 can better identify objects from the surrounding environment. Alternatively, calibrating the wearable computing device 104 may include adjusting one or more thermal sensitivity thresholds of the FLIR camera(s) 312 to adjust the range (e.g., increase and/or decrease) of sensitivity the FLIR camera(s) 312 have to thermal energy. By calibrating the wearable computing device 104 prior to imaging an environment, the wearable computing device 104 can be configured to better detect objects that emit thermal energy.

The wearable computing device 104 then detects one or more objects (e.g., physical objects 106) within its environment (Operation 706). As explained above, the wearable computing device 104 may invoke or execute an object recognition module 218 that detects one or more objects within the environment of the wearable computing device 104. In one embodiment, the object recognition module 218 performs the object detection and/or identification. Additionally, and/or alternatively, the object recognition module 218 communicates with the server 112 via the communication interface 234 to detect and/or identify the one or more objects.

For example, the object recognition module 218 may communicate one or more images to the server 112, which then performs the object identification and/or recognition. In this implementation, the server 112 then communicates the results of the object identification and/or recognition to the object recognition module 218. Information pertaining to the detected and/or identified one or more objects is then stored as the object recognition data 226.

The wearable computing device 104 next obtains thermal imagery from one or more of the detected objects (Operation 708). As explained with reference to FIGS. 2-3, the thermal imaging module 220 communicates with one or more FLIR camera(s) 312 to acquire thermal images of objects within the environment the wearable computing device 104. The acquired thermal images may then be stored as thermal imaging data 228. In addition, the thermal imaging module 220 may then associate the thermal imaging data 228 with one or more detected objects stored as the object recognition data 226 (Operation 710). For example, the thermal imaging module 220 may store one or more identifiers with the thermal imaging data 228, and use the identifiers as references for the object recognition data 226. In this manner, the thermal imaging module 220 can associate detected objects with their respective thermal images. In some instances, the thermal images may be stored as the thermal imaging data 228 without references in the object recognition data 226, such as where the object recognition module 218 is unable to identify and/or detect the object from which the thermal images were acquired.

The AR application 216 then selects augmented reality content (e.g., AR application data 224) to display via the display 204 and the communication bus 234 (Operation 712). In one embodiment, the augmented reality content is selected based on the detected objects (e.g., object recognition data 226) and/or the acquired thermal images (thermal imaging data 228). The augmented reality content may be generated by the AR application 216 or may be generated by the server 112 and communicated to the wearable computing device 104 for display by the AR application 216.

The thermal occlusion module 222 then performs occlusion culling on the content to be displayed on the display 204 according to the comparison of the coordinates associated with the thermal imagery and the coordinates associated with the augmented reality content (Operation 714). In one embodiment, the occlusion culling is performed on a per pixel basis (or per sample basis) for the augmented reality content and/or the thermal imagery to be displayed. Where the thermal occlusion module 222 determines that there are pixels shared by the thermal imagery and the augmented reality content (e.g., the thermal imagery and the augmented reality content have pixels in common), the thermal occlusion module 222 determines that the thermal imagery is to be displayed at the shared pixels rather than the augmented reality content. This determination may be stored as the thermal occlusion data 230.

The AR application 216 then displays the thermal imagery along with augmented reality content according to the occlusion culling performed by the thermal occlusion module 222 (Operation 716). In this manner, the thermal imagery appears overlaid the augmented reality content when viewed through the display 204.

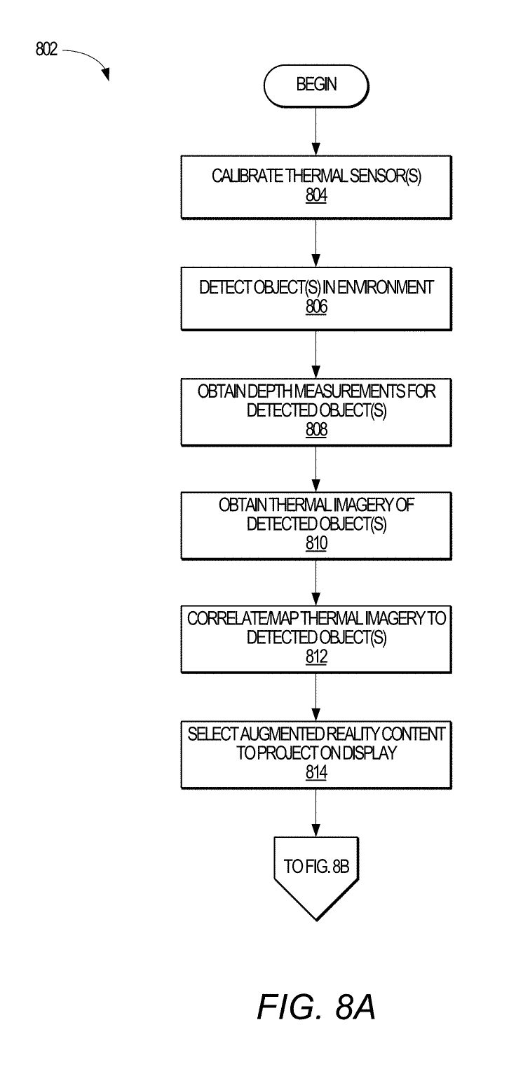

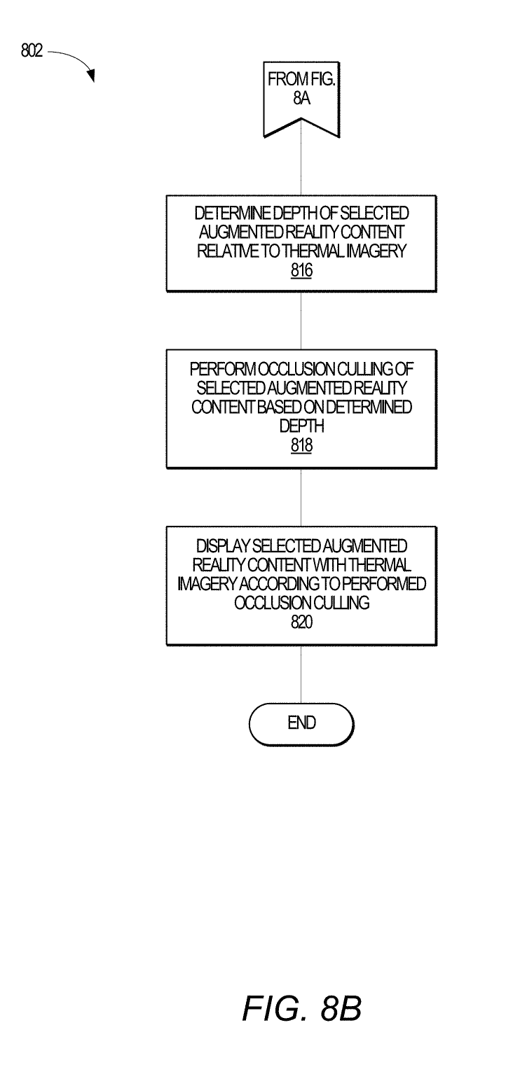

FIGS. 8A-8B illustrate another method 802, according to an example embodiment, implemented by the wearable computing device 104 of FIG. 1 for displaying augmented reality content with thermal images with occlusion. The method 802 may be implemented by one or more components of the wearable computing device 104 and is discussed by way of reference thereto.

Initially, the wearable computing device 104 may be thermally calibrated (Operation 804). Thermally calibrating the wearable computing device 104 may include exposing the one or more FLIR camera(s) 312 to ambient environment temperatures such that the FLIR camera(s) 312 can better identify objects from the surrounding environment. Alternatively, calibrating the wearable computing device 104 may include adjusting one or more thermal sensitivity thresholds of the FLIR camera(s) 312 to adjust the range (e.g., increase and/or decrease) of sensitivity the FLIR camera(s) 312 have to thermal energy. By calibrating the wearable computing device 104 prior to imaging an environment, the wearable computing device 104 can be configured to better detect objects that emit thermal energy.

The wearable computing device 104 then detects one or more objects (e.g., physical objects 106) within its environment (Operation 806). As explained above, the wearable computing device 104 may invoke or execute an object recognition module 218 that detects one or more objects within the environment of the wearable computing device 104. In one embodiment, the object recognition module 218 performs the object detection and/or identification. Additionally, and/or alternatively, the object recognition module 218 communicates with the server 112 via the communication interface 234 to detect and/or identify the one or more objects. For example, the object recognition module 218 may communicate one or more images to the server 112, which then performs the object identification and/or recognition. In this implementation, the server 112 then communicates the results of the object identification and/or recognition to the object recognition module 218. Information pertaining to the detected and/or identified one or more objects is then stored as the object recognition data 226.

Having detected the one or more objects, the object recognition module 218 then determines the distance of the detected one or more objects relative to the wearable computing device 104 (Operation 808). As explained above, this distance may be stored as a depth parameter value. In one embodiment, each pixel representing an object is associated with a depth parameter value; in another embodiment, the object as a whole is associated with a depth parameter value. The depth parameter value indicates the distance of the object detected by the wearable computing device 104 and the wearable computing device 104 itself. Of course, variations and/or combinations of the foregoing are also contemplated as falling within the scope of this disclosure.

The wearable computing device 104 next obtains thermal imagery from one or more of the detected objects (Operation 810). As explained with reference to FIGS. 2-3, the thermal imaging module 220 communicates with one or more FLIR camera(s) 312 to acquire thermal images of objects within the environment the wearable computing device 104. The acquired thermal images may then be stored as thermal imaging data 228. In addition, the thermal imaging module 220 may then associate the thermal imaging data 228 with one or more detected objects stored as the object recognition data 226 (Operation 812). For example, the thermal imaging module 220 may store one or more identifiers with the thermal imaging data 228, and use the identifiers as references for the object recognition data 226. In this manner, the thermal imaging module 220 can associate detected objects with their respective thermal images. In some instances, the thermal images may be stored as the thermal imaging data 230 without references in the object recognition data 226, such as where the object recognition module 218 is unable to identify and/or detect the object from which the thermal images were acquired.

The AR application 216 then selects augmented reality content (e.g., AR application data 224) to display via the display 204 and the communication bus 234. In one embodiment, the augmented reality content is selected based on the detected objects (e.g., object recognition data 226) and/or the acquired thermal images (thermal imaging data 228). The augmented reality content may be generated by the AR application 216 or may be generated by the server 112 and communicated to the wearable computing device 104 for display by the AR application 216.

The augmented reality content may be associated with one or more depth parameters. As discussed above, the depth parameters may take on a normalized range of values from zero to one. By normalizing the depth parameters for the various types of content (e.g., the object recognition data 226, the thermal imaging data 228, and the AR application data 224), the AR application 216 can meaningfully compare the depth parameters of the various types of content to be displayed via the display 204. In one embodiment, prior to displaying the augmented reality content, the AR application 216 compares the depth parameter(s) of the augmented reality content with the depth parameters of the one or more thermal images (Operation 816). In this manner, the AR application 216 determines the placement of the augmented reality content relative to the thermal imagery. Similarly, the one or more depth parameters of the thermal imagery can also be compared with the one or more depth parameters of the object recognition data 226, such that the AR application 216 determines the placement of the thermal imagery relative to the objects detected within the environment of the wearable computing device 104.

The thermal occlusion module 224 then performs occlusion culling on the content to be displayed on the display 204 according to the comparison of the depth parameters (Operation 818). In one embodiment, the occlusion culling is performed on a per pixel basis (or per sample basis) for the augmented reality content and/or the thermal imagery to be displayed. Thus, depending on the depth of the content to be displayed, the augmented reality content may be displayed overlaid the thermal imagery (e.g., as shown in FIG. 4A) or the thermal imagery may appear overlaid on the augmented reality content (e.g., as shown in FIG. 4B). The AR application 216 then displays the thermal imagery along with augmented reality content according to the occlusion culling performed by the thermal occlusion module 224 (Operation 820). In this manner, by performing occlusion culling on the augmented reality content and/or the thermal imagery, the thermal occlusion module 224 reduces the overall workload of the processor(s) 202 and reduces the amount of computing resources used by the AR application 216 in displaying the various types of content (e.g., augmented reality content and thermal imagery) on the display 204.

Thus, this disclosure provides for a wearable computing device 104 configured to acquire thermal imagery for objects within an environment. The acquired thermal imagery may be displayed simultaneously with augmented reality content such that the acquired thermal imagery appears overlaid on corresponding objects. Furthermore, using one or more hidden surface techniques (e.g., occlusion culling techniques) the wearable computing device 104 is configured to present augmented reality content and thermal imagery that is positionally, and relatively, correct. Thus, augmented reality content that is supposed to appear overlaid thermal imagery does, in fact, appear overlaid thermal imagery and thermal imagery that is supposed to appear overlaid augmented reality content does, in fact, appear overlaid the augmented reality content. As mentioned above, the occlusion culling technique performed in this manner has a technical benefit on the wearable computing device 104 in that the wearable computing device 104 uses less resources in the display of the augmented reality content and the thermal imagery. This feature can be especially important where electrical power and computing resources are prime assets in a mobile environment. Yet another important benefit is that the user 120, having adorned the wearable computing device 104, sees the augmented reality content and the thermal imagery that makes sense to his or her notions of common sense (e.g., background augmented reality content appears “underneath” thermal imagery). This feature further enhances the user's experience with the wearable computing device 104.

### Modules, Components, and Logic

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Example Machine Architecture and Machine-Readable Medium

FIG. 9 is a block diagram illustrating components of a machine 900, according to some example embodiments, able to read instructions from a machine-readable medium (e.g., a machine-readable storage medium) and perform any one or more of the methodologies discussed herein. Specifically, FIG. 9 shows a diagrammatic representation of the machine 900 in the example form of a computer system, within which instructions 916 (e.g., software, a program, an application, an applet, an app, or other executable code) for causing the machine 900 to perform any one or more of the methodologies discussed herein may be executed. For example, the instructions may cause the machine to execute the method illustrated in FIGS. 7-8B. Additionally, or alternatively, the instructions may implement one or more of the modules 212 illustrated in FIG. 2 and so forth. The instructions transform the general, non-programmed machine into a particular machine programmed to carry out the described and illustrated functions in the manner described. In alternative embodiments, the machine 900 operates as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 916, sequentially or otherwise, that specify actions to be taken by machine 900. Further, while only a single machine 900 is illustrated, the term “machine” shall also be taken to include a collection of machines 900 that individually or jointly execute the instructions 916 to perform any one or more of the methodologies discussed herein.

The machine 900 may include processors 910, memory 930, and I/O components 950, which may be configured to communicate with each other such as via a bus 902. In an example embodiment, the processors 910 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 912 and processor 914 that may execute instructions 916. The term “processor” is intended to include multi-core processor that may comprise two or more independent processors (sometimes referred to as “cores”) that may execute instructions contemporaneously. Although FIG. 9 shows multiple processors, the machine 900 may include a single processor with a single core, a single processor with multiple cores (e.g., a multi-core process), multiple processors with a single core, multiple processors with multiples cores, or any combination thereof.

The memory/storage 930 may include a memory 932, such as a main memory, or other memory storage, and a storage unit 936, both accessible to the processors 910 such as via the bus 902. The storage unit 936 and memory 932 store the instructions 916 embodying any one or more of the methodologies or functions described herein. The instructions 916 may also reside, completely or partially, within the memory 932, within the storage unit 936, within at least one of the processors 910 (e.g., within the processor's cache memory), or any suitable combination thereof, during execution thereof by the machine 900. Accordingly, the memory 932, the storage unit 936, and the memory of processors 910 are examples of machine-readable media.

As used herein, “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 916. The term “machine-readable medium” shall also be taken to include any medium, or combination of multiple media, that is capable of storing instructions (e.g., instructions 916) for execution by a machine (e.g., machine 900), such that the instructions, when executed by one or more processors of the machine 900 (e.g., processors 910), cause the machine 900 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 950 may include a wide variety of components to receive input, provide output, produce output, transmit information, exchange information, capture measurements, and so on. The specific I/O components 950 that are included in a particular machine will depend on the type of machine. For example, portable machines such as mobile phones will likely include a touch input device or other such input mechanisms, while a headless server machine will likely not include such a touch input device. It will be appreciated that the I/O components 950 may include many other components that are not shown in FIG. 9. The I/O components 950 are grouped according to functionality merely for simplifying the following discussion and the grouping is in no way limiting. In various example embodiments, the I/O components 950 may include output components 952 and input components 954. The output components 952 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 954 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 950 may include biometric components 956, motion components 958, environmental components 960, or position components 962 among a wide array of other components. For example, the biometric components 956 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 958 may include acceleration sensor components (e.g., accelerometer), gravitation sensor components, rotation sensor components (e.g., gyroscope), and so forth. The environmental components 960 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 962 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 950 may include communication components 964 operable to couple the machine 900 to a network 980 or devices 970 via coupling 982 and coupling 972 respectively. For example, the communication components 964 may include a network interface component or other suitable device to interface with the network 980. In further examples, communication components 964 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 970 may be another machine or any of a wide variety of peripheral devices (e.g., a peripheral device coupled via a Universal Serial Bus (USB)).

Moreover, the communication components 964 may detect identifiers or include components operable to detect identifiers. For example, the communication components 964 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 964, such as, location via Internet Protocol (IP) geo-location, location via Wi-Fi® signal triangulation, location via detecting a NFC beacon signal that may indicate a particular location, and so forth.

### Transmission Medium

In various example embodiments, one or more portions of the network 980 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 980 or a portion of the network 980 may include a wireless or cellular network and the coupling 982 may be a Code Division Multiple Access (CDMA) connection, a Global System for Mobile communications (GSM) connection, or other type of cellular or wireless coupling. In this example, the coupling 982 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 916 may be transmitted or received over the network 980 using a transmission medium via a network interface device (e.g., a network interface component included in the communication components 964) and utilizing any one of a number of well-known transfer protocols (e.g., hypertext transfer protocol (HTTP)). Similarly, the instructions 916 may be transmitted or received using a transmission medium via the coupling 972 (e.g., a peer-to-peer coupling) to devices 970. The term “transmission medium” shall be taken to include any intangible medium that is capable of storing, encoding, or carrying instructions 916 for execution by the machine 900, and includes digital or analog communications signals or other intangible medium to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

We claim:

1. A wearable computing device for providing augmented reality images of an environment in which the wearable computing device is worn, the wearable computing device comprising:
a machine-readable memory storing computer-executable instructions; and
at least one hardware processor in communication with the machine-readable memory that, when the computer-executable instructions are executed, configures a wearable computing device to perform a plurality of operations, the plurality of operations comprising:
acquiring, by one or more cameras of the wearable computing device, thermal data in an environment in which the wearable computing device is being worn;
obtaining augmented reality content to be displayed within the wearable computing device; and
occluding one or more portions of the augmented reality content based on the thermal data.

2. The wearable computing device of claim 1, wherein the plurality of operations further comprises:
displaying a thermal image corresponding to the thermal data with the occluded one or more portions of the augmented reality content.

3. The wearable computing device of claim 1, wherein the plurality of operations further comprises:
identifying a first plurality of coordinates corresponding to the augmented reality content;
identifying a second plurality of coordinates corresponding to the thermal image;
identifying a third plurality of coordinates selected from the first plurality of coordinates and the second plurality of coordinates, the third plurality of coordinates corresponding to coordinates that the first plurality of coordinates and the second plurality of coordinates have in common; and wherein
the thermal image is displayed at the third plurality of coordinates instead of the augmented reality content.

4. The wearable computing device of claim 1, wherein the plurality of operations further comprises:
obtaining instructions whether one or more portions of the thermal image are to be occluded based on a comparison of at least one depth parameter value of the augmented reality content with the at least one depth parameter value of the thermal image; and
in response to the obtained instructions indicating that one or more portions of the thermal image are to be occluded, displaying the augmented reality content instead of the one or more portions of the thermal image.

5. The wearable computing device of claim 1, wherein the thermal image comprises a plurality of pixels; and
the plurality of operations further comprises determining at least one depth parameter value for each pixel of the plurality of pixels.

6. The wearable computing device of claim 1, wherein occluding the one or more portions of the augmented reality content comprises:
communicating the thermal data to a computer-implemented server in communication with the wearable computing device; and
receiving instructions indicating which of the one or more portions of the augmented reality content are to be occluded.

7. The wearable computing device of claim 1, wherein a depth parameter value of the thermal image indicates a distance of an object associated with the thermal image from the wearable computing device.

8. The wearable computing device of claim 1, wherein displaying the thermal image instead of the augmented reality content includes displaying one or more portions of the augmented reality content that are not to be occluded.

9. A computer-implemented method for providing augmented reality images of an environment in which the wearable computing device is worn, the computer-implemented method comprising:
acquiring, by one or more cameras of the wearable computing device, thermal data in an environment in which the wearable computing device is being worn;
obtaining augmented reality content to be displayed within the wearable computing device; and
occluding one or more portions of the augmented reality content based on the thermal data.

10. The computer-implemented method of claim 9, further comprising:
displaying a thermal image corresponding to the thermal data with the occluded one or more portions of the augmented reality content.

11. The computer-implemented method of claim 9, further comprising:
identifying a first plurality of coordinates corresponding to the augmented reality content;
identifying a second plurality of coordinates corresponding to the thermal image;
identifying a third plurality of coordinates selected from the first plurality of coordinates and the second plurality of coordinates, the third plurality of coordinates corresponding to coordinates that the first plurality of coordinates and the second plurality of coordinates have in common; and wherein
the thermal image is displayed at the third plurality of coordinates instead of the augmented reality content.

12. The computer-implemented method of claim 9, further comprising:
obtaining instructions whether one or more portions of the thermal image are to be occluded based on a comparison of at least one depth parameter value of the augmented reality content with the at least one depth parameter value of the thermal image; and
in response to the obtained instructions indicating that one or more portions of the thermal image are to be occluded, displaying the augmented reality content instead of the one or more portions of the thermal image.

13. The computer-implemented method of claim 9, wherein the thermal image comprises a plurality of pixels; and
the method further comprises determining at least one depth parameter value for each pixel of the plurality of pixels.

14. The computer-implemented method of claim 9, wherein occluding the one or more portions of the augmented reality content comprises:
communicating the thermal data to a computer-implemented server in communication with the wearable computing device; and
receiving instructions indicating which of the one or more portions of the augmented reality content are to be occluded.

15. The computer-implemented method of claim 9, wherein at least one depth parameter value of the thermal image indicates a distance of an object associated with the thermal image from the wearable computing device.

16. The computer-implemented method of claim 9, wherein displaying the thermal image instead of the augmented reality content includes displaying one or more portions of the augmented reality content that are not to be occluded.

17. A machine-readable memory storing computer-executable instructions that, when executed by at least one hardware processor, configures a wearable computing device to perform a plurality of operations, the plurality of operations comprising:
acquiring, by one or more cameras of the wearable computing device, thermal data in an environment in which the wearable computing device is being worn;
obtaining augmented reality content to be displayed within the wearable computing device; and
occluding one or more portions of the augmented reality content based on the thermal data.

18. The machine-readable memory of claim 17, wherein the plurality of operations further comprises:
identifying a first plurality of coordinates corresponding to the augmented reality content;
identifying a second plurality of coordinates corresponding to the thermal image;
identifying a third plurality of coordinates selected from the first plurality of coordinates and the second plurality of coordinates, the third plurality of coordinates corresponding to coordinates that the first plurality of coordinates and the second plurality of coordinates have in common; and wherein
the thermal image is displayed at the third plurality of coordinates instead of the augmented reality content.

19. The machine-readable memory of claim 17, wherein the plurality of operations further comprises:
obtaining instructions whether one or more portions of the thermal image are to be occluded based on a comparison of at least one depth parameter value of the augmented reality content with at least one depth parameter value of the thermal image; and
in response to the obtained instructions indicating that one or more portions of the thermal image are to be occluded, displaying the augmented reality content instead of the one or more portions of the thermal image.

20. The machine-readable memory of claim 17, wherein the thermal image comprises a plurality of pixels; and
the plurality of operations further comprises determining at least one depth parameter value for each pixel of the plurality of pixels.
